(19) United States
(12) Patent Application Publication
(10) Pub. No.: US 2018/0023770 A1
(43) Pub. Date: Jan. 25, 2018

(54) FILAMENT UNIT FOR RETROFIT LED TUBE

(71) Applicant: PHILIPS LIGHTING HOLDING B.V., EINDHOVEN (NL)

(72) Inventors: Raimundo DE HEER GALISTEO, EINDHOVEN (NL); Bernhard Christiaan VAN DIJK, EINDHOVEN (NL); Haimin TAO, EINDHOVEN (NL); Tian Xiang WEN, EINDHOVEN (NL); Sascha KONDIC, EINDHOVEN (NL); Pieter Johannes STOBBELAAR, EINDHOVEN (NL); Paul Robert VELDMAN, EINDHOVEN (NL)

(21) Appl. No.: 15/546,543

(22) PCT Filed: Jan. 28, 2016
(86) PCT No.: PCT/EP2016/051799

§ 371 Date: Jul. 26, 2017

(30) Foreign Application Priority Data
Feb. 3, 2015 (CN) PCT/CN2015/000077
Apr. 1, 2015 (EP) 15162147.1

(51) Int. Cl. F21K 9/272; F21K 9/278; H01K 1/44; H01K 1/28

(52) U.S. Cl. CPC F21K 9/272; H01K 1/28; F21K 9/278; H01K 1/44; F21Y 2115/10

(57) ABSTRACT

The invention relates to a light emitting device (2) for retrofitting a fluorescent lamp comprising two sets of connecting pins (21, 23, 21′, 23′) for connecting the light emitting system (1) to a lighting fixture, one first (611) and one second (613) filament unit, encapsulated in a bulb and fed through it, electrically coupled to the connecting pins (611, 613) and a solid state light source connected between the filament units.

### FIELD OF THE INVENTION

The present invention relates generally to a light emitting system, and more particularly to a Light Emitting Diode (LED) lamp that can be compatibly retrofitted into various lighting fixtures having ballasts, and notably High Frequency (HF) ballasts.

### BACKGROUND

LEDs play an increasingly significant role in general lighting applications. As a result, more and more new installations are equipped with LED light sources in various ways. The reason for replacing state of the art light sources with LED light sources is the low power consumption of LED light sources and their extremely long lifetime. Further, compared to the lifetime of for example fluorescent type light sources, the lifetime of respective housings for receiving the fluorescent type light sources and the respective drivers for powering the fluorescent type light sources is rather long. Thus, it seems to be attractive if a user could simply replace such kind of fluorescent type light sources.

There are many commercial, industrial, and retail environments, such as factories, stores, warehouses, and office buildings that are equipped with a large number of lighting fixtures with installed fluorescent tubes, such as tubes of the types designated as T8 or T12, and accompanying HF ballasts, also commonly referred to as electronic ballasts.

LED-based luminaires tend to be advantageous replacement solutions for fluorescent tubes. LED-based tubes are commonly designated as “LED tubes” or by the acronym “TLEDs”. There are various existing LED tubes nowadays, most of them being designed to be supplied by a mains input, such LED tubes being commonly designated as “mains compatible”.

Fluorescent light sources, such as tubular fluorescent lamps, commonly referred to as “TL-tubes” typically comprise a filament at each end of the lamp, which are connected in series with the ballast at least during a required preheat period, so that an arc can properly be struck in the gas-filled tube.

Modern electronic ballasts or drivers comprise features for allowing identification of TL-tubes; for instance, they can comprise means for measuring a resistance value of the filaments in order to detect the type of TL-tube connected to the ballast. Such a measurement of a filament resistance is advantageous since typically different tube types require different driving power requirements. For example, the length of a TL-tube influences the burning voltage of the tube and hence the power level. In case an LED retrofit tube is connected to such an intelligent tube driver, due to the presence of LEDs and not simple TL-tube filaments the tube driver might measure an unexpected filament resistance value and hence quit operation. Thus most of electronic ballasts need filament detection features in order to be properly started up.

Known solutions consist of using filament circuits that emulate the presence of a fluorescent lamp, by mimicking the resistance or impedance of the filaments. As illustrated by FIG. 1, a filament emulation circuit 1 is typically put in series with connecting pins 11, 13 of each end cap of a TLED 10, and comprises two resistors R1, R2 in series. Expected power dissipation in the resistors R1 or R2 depends on the configuration according to which the electronic ballast is connected to the connecting pins 11, 13. HF lamp-current flows through the resistors R1 or R2, which results in continuous overheating of the resistors R1, R2. Such prior arts are like WO2015/014680A1, EP2378839A2, US2011/043127A1 and WO2009/136322A1.

### SUMMARY OF THE INVENTION

It is an object of the present invention to solve the incompatibility issues that may occur between TLEDs and some electronic ballasts, with a solution that is advantageous over filament emulation circuits in this respect.

The invention is defined by the claims.

A basic idea of the embodiments of the invention is using a real filament of traditional lamp such as fluorescent lamp to provide the compatibility with the ballasts. The fluorescent lamp filament in the embodiment would also reduce the power loss due to its positive temperature coefficient. Further, the basic idea also proposes to add a bulb to encapsulate the filament so as to increase its temperature and further reduce power loss.

One aspect of the invention is a light emitting device for retrofitting a fluorescent lamp comprising a light emitting unit comprising at least a solid state light source, two sets of connecting pins for connecting the light emitting system to a lighting fixture, wherein each set of connecting pins is electrically coupled to at least one filament unit, said filament unit comprising at least one first and one second filament unit connecting pins, and at least one filament electrically coupled to the filament unit connecting pins, wherein the filament unit further comprises a bulb encapsulating at least the at least one filament, the filament unit connecting pins being fed through the bulb.

The present application proposes to use a real filament, without using anything else to emulate the filament. Thus ballast would recognize the light emitting device even better since the ballast detects the completely real filament. This gives a better compatibility between the solid state light emitting device and traditional lighting fixture such as ballast.

More specifically, the filament is a traditional filament of fluorescent lamps. Even further, the filament has a positive temperature coefficient and is capable of emitting light as current passing through the filament.

As the current through the filament heats the filament, the temperature of the filament increases, and the impedance of the filament also increases. The increased impedance will reduce the power loss on the filament, in turn, the overheating problem is overcome. A typical filament has a hot/cold ration of 4. So when it is hotter, loss power is dissipated. Further, the light emitting device configures the bulb keeping the heat inside the bulb. As a result, the filament gets hotter and therefore impedance becomes high more quickly, thus reducing the power loss even better.

In a first exemplary embodiment of the invention, the filament unit connecting pins can be electrically coupled to respective connecting rods that are electrically coupled to the at least one filament.

In a second exemplary embodiment of the invention, the filament unit can comprise two filaments electrically coupled in series, and between said first and second filament unit connecting pins, and can further comprise a third filament unit connecting pin electrically coupled to a common node between said two filaments, the third filament unit connecting pin being fed through the bulb.

In an exemplary embodiment of the invention, the filament unit can further comprise a stem at least partly encapsulated in the bulb, the connecting rods and the filament unit connecting pins being mechanically attached to the stem.

In an exemplary embodiment of the invention, the bulb can be made of glass.

In an exemplary embodiment of the invention, the bulb can be filled in with a gas. The gas is to cool down the filament and bring the generated heat more easily to the environment. The bulb and the gas achieve a thermal balance with the environment, so the temperature of the filament is at an optimal temperature. In this temperature, the filament reduces power loss as well as is prevented from being damaged from over high temperature.

In an exemplary embodiment of the invention, each set of connecting pins can be electrically coupled to one respective filament unit as in the first aspect above or its first exemplary embodiment, one filament unit connecting pin being electrically coupled to the first connecting pin and the other filament unit connecting pin being electrically coupled to the second connecting pin and to the light emitting unit.

In an exemplary embodiment of the invention, each set of connecting pins can be electrically coupled to two respective filament units as in the first aspect above or its first exemplary embodiment connected in series with each other, a common node between the two filament units being electrically coupled to the light emitting unit.

In an exemplary embodiment of the invention, each set of connecting pins can be electrically coupled to one respective filament unit as in the second exemplary embodiment above, the first filament unit connecting pin being electrically coupled to the first connecting pin, the second filament unit connecting pin being electrically coupled to the second connecting pin and the third filament unit connecting pin being electrically coupled to the light emitting unit.

In an exemplary embodiment, the light emitting device can comprise two end caps, wherein each end cap comprises two connecting pins and at the at least one filament unit.

Another aspect of the invention is a method for improving compatibility of a light emitting device of solid state light sources with electronic ballasts, comprising electrically coupling at least one filament unit as defined in any of the described embodiments to at least one set of connecting pins of the light emitting device of solid state light source, wherein the filament unit comprises a bulb encapsulating at least one filament which is a traditional filament of lamps and capable of emitting light as current passing through the filament and has a positive temperature coefficient.

These and other aspects of the invention will be apparent from and elucidated with reference to the embodiment(s) described hereinafter.

### BRIEF DESCRIPTION OF THE DRAWINGS

Examples of the invention will now be described in detail with reference to the accompanying drawings, in which:

FIG. 1 shows an electrical diagram of a filament emulation circuit in a HF-ballast compatible TLED;

FIG. 2 shows a diagram illustrating a light emitting device notably comprising filament units, in accordance with a first embodiment of the invention;

FIG. 3 shows a diagram illustrating a retrofit TLED comprising filament units, in accordance with a second embodiment of the invention;

FIG. 4 shows a diagram illustrating a retrofit TLED comprising filament units, in accordance with a third embodiment of the invention;

FIG. 5 shows a diagram schematically illustrating a filament unit as used in the third embodiment;

FIG. 6 shows a detailed view of a filament unit as described in the first and second embodiments.

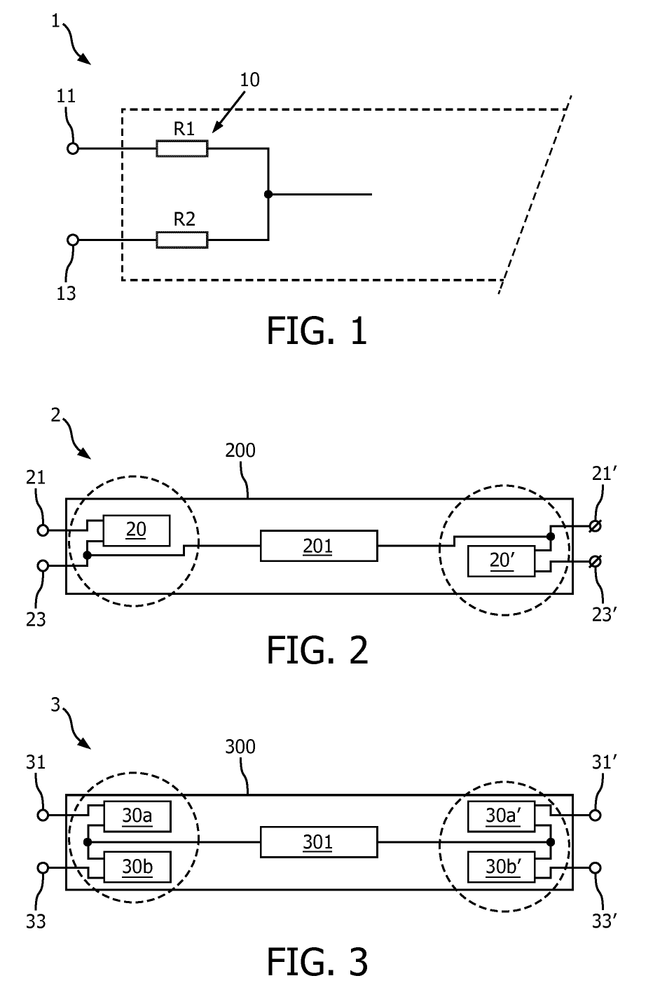

### DETAILED DESCRIPTION

The inventive concept underlying the invention is that a retrofit light emitting system can be equipped with an actual filament unit, essentially in the form of a discrete component designed to be coupled with the connecting pins of the light emitting system. A light emitting system can be provided with at least one such filament unit, or a filament unit can be provided as such, to be coupled to an existing light emitting system for the purpose of improving its compatibility with existing electronic ballasts. Different embodiments of a light emitting system in accordance with one aspect of the invention are described hereinafter, as well as embodiments of a filament unit.

FIG. 2 shows a diagram illustrating a light emitting device notably comprising filament units, in accordance with a first embodiment of the invention.

A light emitting device 2 comprises a housing 200 of substantially elongated (tubular) shape. The housing 200 can comprise a transparent or translucent tube, as well as caps mechanically coupled to the tube at two opposite ends of the housing 200, as described further in detail below.

The light emitting device 2 further comprises a light emitting unit 201. The light emitting device 2 can be a LED retrofit lamp, such as a linear tube lamp or TLED. The light emitting device 2 comprises a couple of connecting pins 21, 23 and 21′, 23′ respectively at its both opposite ends. For example, the connecting pins 21, 23 and 21′, 23′ are arranged in two caps, in a so-called double-capped TLED. The lamp caps can thus for example be provided with a corresponding contact element, such as a bi-pin base. For example, the lamp caps may have the electrical and/or mechanical properties of a T5 or T8-fluorescent lamp.

The light emitting unit 201 may comprise at least one of any type of solid state light source, such as an inorganic LED or an organic LED, commonly referred to as OLED. For example, in a typical retrofit application, the total flux of the light emitting unit can be in the range of 300 lm to 10000 lm, which corresponds to a typical 5 W to 80 W fluorescent tube lamp. The forward voltage of the light emitting unit can for instance be in the range of 30 V to 200 V, particularly 50 V to 100 V for a 4-foot-lamp (1 foot=0.3048 m).

The light emitting unit 201 may comprise further electric or electronic components, such as an LED driver unit, e.g., to set the brightness and/or colour, rectifying circuitry, a smoothing stage, a filter capacitor and/or a discharging protection diode. The light emitting unit 201 may comprise more than one LED, for example in applications where colour-control of the emitted light is desired, e.g., using RGB-LEDs, or to further increase the luminous flux of the light emitting device.

The light emitting device 2 may be adapted to be connected to a PL-type fluorescent lamp fixture. The light emitting device 2 can comprise at least a first and second lamp caps. The lamp caps should be adapted to provide an electrical connection of the light emitting unit 201 with the respective lamp fixture and thus with power.

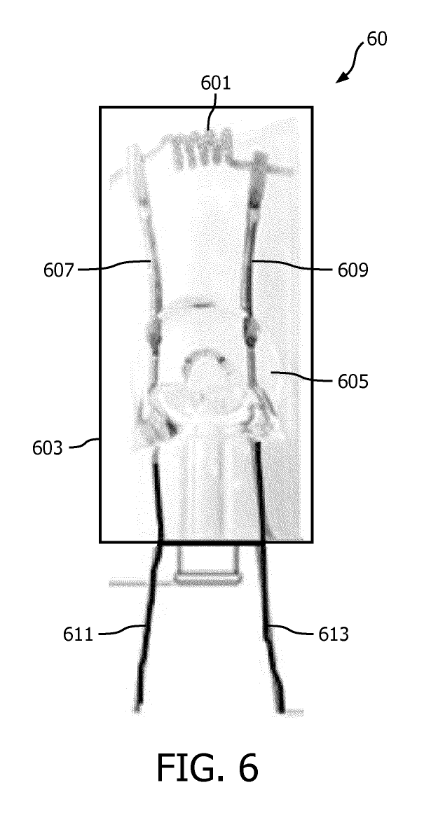

In accordance with a specificity of the invention, a given set of connecting pins 21, 23 and/or 21′, 23′ can be electrically coupled to a filament unit 20 and/or 20′. Exemplary structures of a filament unit are described in more detail hereinafter, notably in reference to FIGS. 5 and 6.

In the example illustrated by FIG. 2, a first filament unit 20 is electrically coupled in series between the first connecting pin 21 and the second connecting pin 23 of a first end of the light emitting device 2, the second connecting pin 23 being for example electrically coupled to the light emitting device 2. In a similar manner, a second filament unit 20′ is electrically coupled in series between the first connecting pin 21′ and the second connecting pin 23′ of a second end of the light emitting device 2, the first connecting pin 23′ being for example electrically coupled to the light emitting device 2.

FIG. 3 shows a diagram illustrating a light emitting device notably comprising filament units, in accordance with a second embodiment of the invention.

In the exemplary embodiment illustrated by FIG. 3, a light emitting device 3 can comprise a housing 300, a light emitting unit 301, a first and a second connecting pins 31, 33 at a first end and a first and second connecting pins 31′, 33′ at a second end, in a way similar as light emitting device 2 described above in reference to FIG. 2.

In accordance with a specificity of the second embodiment, two filament units 30a, 30b are electrically coupled in series with each other, and between the first connecting pin 31 and the second connecting pin 33 of the first end of the light emitting device 3; in a similar manner, two filament units 30′a, 30′b are electrically coupled in series with each other, and between the first connecting pin 31′ and the second connecting pin 33′ of the second end of the light emitting device 3.

The common node of the two filament units 30a, 30b is electrically coupled to the light emitting unit 301; similarly, a common node of the two filament units 30a′, 30b′ is electrically coupled to the light emitting unit 301.

One advantage of the second embodiment is that it allows a reduced power distribution in the filament at each end of the light emitting device 3. This symmetrical filament configuration allows main lamp current to flow through only half of the total filament resistance, thereby reducing the dissipation.

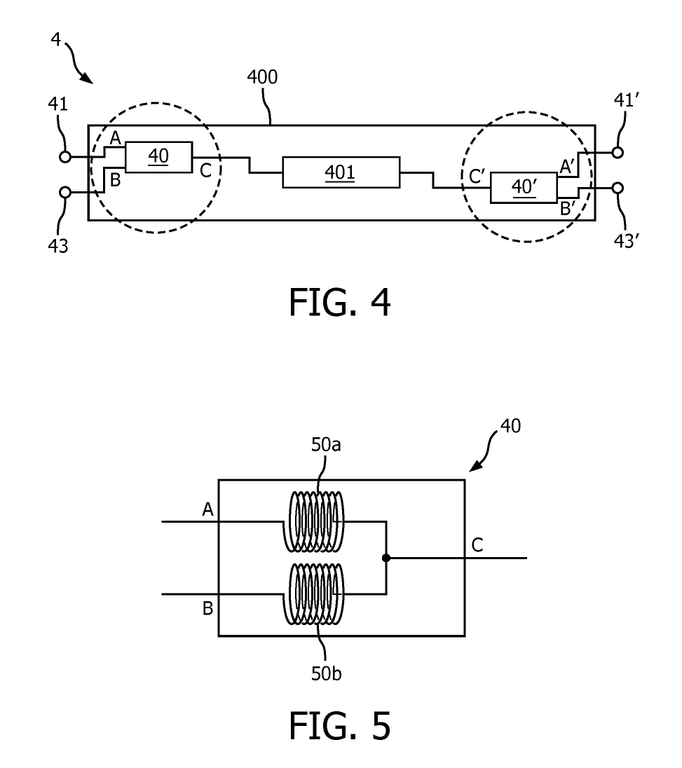

FIG. 4 shows a diagram illustrating a light emitting device notably comprising filament units, in accordance with a third embodiment of the invention.

In the exemplary embodiment illustrated by FIG. 4, a light emitting device 4 can comprise a housing 400, a light emitting unit 401, a first and a second connecting pins 31, 33 at a first end and a first and second connecting pins 31′, 33′ at a second end, in a way similar as light emitting device 3 described above in reference to FIG. 3.

In accordance with a specificity of the third embodiment, one filament unit 40 is electrically coupled between the first connecting pin 41 and the second connecting pin 43 of the first end of the light emitting device 4 by means of a first filament unit connecting pin A and a second filament unit connecting pin B, and is electrically coupled to the light emitting unit 401 by means of a third filament unit connecting pin C. In a similar manner, one filament unit 40′ is electrically coupled between the first connecting pin 41′ and the second connecting pin 43′ of the first end of the light emitting device 4 by means of a first filament unit connecting pin A′ and a second filament unit connecting pin B′, and is electrically coupled to the light emitting unit 401 by means of a third filament unit connecting pin C′.

In the third embodiment, each filament unit 40, 40′ comprises two filaments coupled in series. As illustrated by FIG. 5, a filament unit 40 can comprise two filaments 50a, 50b, the third filament unit connecting pin C being electrically coupled to a node between the two filaments 50a, 50b, in such a way that the equivalent circuit of the arrangement in accordance with the second embodiment is identical to that of the arrangement in accordance with the third exemplary embodiment.

The third embodiment has the same advantages as the second embodiment in term of power dissipation. A further advantage of the third embodiment is that the use of two integrated dual filament units is more compact and cost-efficient in comparison with the use of four filament units.

FIG. 6 shows a detailed view of a filament unit as described in the first and second embodiments.

The filament unit 60 illustrated by FIG. 6 corresponds to one of the first or second exemplary embodiment described above, that is: the filament unit 60 comprises two filament unit connecting pins 611, 613 adapted for electrical coupling to corresponding respective connecting pins of a lighting device.

The filament unit 60 comprises a filament 601. The ends of the filament 601 can respectively be electrically coupled to two filament connecting rods 607, 609. The filament connecting rods 607, 609 can respectively be electrically coupled to the two filament unit connecting pins 611, 613.

The filament unit 60 further comprises a stem 605. The two filament connecting rods 607, 609 and filament unit connecting pins 611, 613 can be mechanically coupled to the stem 605, for example the two filament connecting rods 607, 609 and filament unit connecting pins 611, 613 can be firmly attached respectively at both sides of a protruding part of the stem 605, as illustrated in FIG. 6. The stem 605 can further comprise a foot base part attached to the bulb 603, for example level with the bottom side of the bulb 603 as in the illustrated embodiment. The bulb 603 and the stem 605 can for example be formed together in a unique part. In some embodiments, a filament connecting rod 607, 609 and the corresponding filament unit connecting pin 611, 613 can form a single part, which is fed through the stem 605.

The filament unit 60 further comprises a bulb 603 that encapsulates at least the filament 601, the filament connecting rods 607, 609 and at least partly the stem 605 and the filament unit connecting pins 611, 613. The filament unit connecting pins 611, 613 are fed through the bulb 603 in such a manner that an end of each filament unit connecting pin 611, 613 emerges out the bulb 603. The bulb 603 can for example be made of glass or any material offering a similarly low thermal conductivity, or any material offering good thermal and electrical insulation, which can withstand high temperatures and vacuum. The encapsulation by the bulb 603 can be done in a gas-tight manner, and a vacuum can be made inside the glass bulb to protect the filament from oxidation, or the glass bulb 603 may be advantageously filled with a gas or fluid for an improved cooling of the filament 601, through better conduction of the heat emitted by the filament 601 to the environment. For example, the glass bulb 603 can be filled with a light gas presenting a high thermal conductivity, such as helium. In some cases it may be advantageous to keep low thermal conductivity so that the bulb surface temperature is kept within acceptable level. This may be required if the bulb is assembled close by electronic components of the light emitting unit (201, 301, 401) or the LEDs.

The filament unit may comprise a third filament unit connecting pin, as per the third exemplary embodiment described above. In such case, the third filament unit connecting pin can be fed through e.g. the top of the bulb, so as to offer an end that emerges out the bulb, the other end being electrically connected to a node between two filaments.

The filament 601 can be adapted to provide thermal conductivity and/or electrical characteristics that are similar to those of typical filaments used in fluorescent tubes. For example the filament 601 can be made of tungsten, and wound into a shape resembling a coil. The filament 601 can be coated with a coating layer, which can either or not have light emitting properties.

While the invention has been illustrated and described in detail in the drawings and foregoing description, such illustration and description are to be considered illustrative or exemplary and not restrictive. The invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A light emitting device for retrofitting a fluorescent lamp comprising a light emitting unit comprising:
at least a solid state light source,
two sets of connecting pins for connecting the light emitting device to a lighting fixture, characterized in that
the light emitting device further comprises at least one filament unit, wherein each set of connecting pins is electrically coupled to the at least one filament unit,
wherein said filament unit comprises
at least one first and one second filament unit connecting pins, and
at least one filament electrically coupled to the filament unit connecting pins, wherein the filament has a positive temperature coefficient, and wherein the filament unit further comprises a bulb encapsulating at least the at least one filament, the filament unit connecting pins being fed through the bulb.

2. A light emitting device as claimed in claim 1, wherein the filament is a traditional filament of fluorescent lamps.

3. A light emitting device as claimed in claim 1, wherein the filament is capable of emitting light as current passing through the filament.

4. A light emitting device as claimed in claim 1, wherein the filament unit connecting pins are electrically coupled to respective connecting rods that are electrically coupled to the at least one filament.

5. A light emitting device as claimed in claim 1, wherein the filament unit comprises two filaments electrically coupled in series, and between said first and second filament unit connecting pins, wherein the filament unit further comprises a third filament unit connecting pin electrically coupled to a common node between said two filaments, the third filament unit connecting pin being fed through the bulb.

6. A light emitting device as claimed in claim 1, wherein the filament unit further comprises a stem at least partly encapsulated in the bulb, the connecting rods and the filament unit connecting pins being mechanically attached to the stem.

7. A light emitting device as claimed in claim 1, wherein the bulb of the the filament unit is made of glass.

8. A light emitting device as claimed in claim 1, wherein the bulb of the filament unit is filled in with a gas.

9. A light emitting device as claimed in claim 1, wherein each set of connecting pins is electrically coupled to one respective filament unit.

10. A light emitting device as claimed in claim 1, wherein each set of connecting pins is electrically coupled to two respective filament units.

11. A light emitting device as claimed in claim 1, wherein each set of connecting pins is electrically coupled to one respective filament unit.

12. A light emitting device as claimed in claim 1, comprising two end caps, wherein each end cap comprises two connecting pins and at the at least one filament unit.

13. A method for improving compatibility of a light emitting device of solid state light sources with electronic ballasts, comprising electrically coupling at least one filament unit to at least one set of connecting pins of the light emitting device of solid state light source, wherein the filament unit comprises a bulb encapsulating at least one filament which is a traditional filament of lamps and capable of emitting light as current passing through the filament and has a positive temperature coefficient.
